(19) United States
(12) Patent Application Publication
(10) Pub. No.: US 2014/0058808 A1
(43) Pub. Date: Feb. 27, 2014

(54) MOBILE DEVICE USING POSITION AND EXTERNAL CONDITION TO SELECT RELATED ADVERTISING AND SELECTION METHOD THEREOF

(71) Applicants: MITAC INTERNATIONAL CORP., TAOYUAN COUNTY (TW); MITAC RESEARCH (SHANGHAI) LTD., Shanghai City (CN)

(72) Inventor: Wei-Chiang CHO, Taoyuan City (TW)

(73) Assignees: MITAC RESEARCH (SHANGHAI) LTD., Shanghai City (CN); MITAC INTERNATIONAL CORP., TAOYUAN COUNTY (TW)

(21) Appl. No.: 13/755,753

(22) Filed: Jan. 31, 2013

(30) Foreign Application Priority Data
Aug. 23, 2012 (CN) 201210302633.9

(51) Int. Cl. G06Q 30/02

(52) U.S. Cl. CPC G06Q 30/0261; G06Q 30/0252
USPC 705/14.5; 705/14.58

(57) ABSTRACT

The present invention discloses a mobile device using position and external condition to select related advertising and a selection method thereof The mobile device comprises a storage module, a positioning module, a processing module and a display module. The storage module is provided for storing a plurality pieces of advertising information. The positioning module is provided for receiving a current position of the mobile device. The processing module is provided for reading a situational parameter of the mobile device or a characteristic parameter of a target user, and reading a plurality pieces of advertising information of the corresponding current position and situational parameter or characteristic parameter according to the current position, and the situational parameter or the characteristic parameter, and updating the advertising information according to the current position. The display module is provided for displaying plurality pieces of corresponding advertising information.

### CROSS-REFERENCE TO RELATED APPLICATION

This application claims the benefit of China Patent Application No. 201210302633.9, filed on Aug. 23, 2012, in the State Intellectual Property Office of the People's Republic of China, the disclosure of which is incorporated herein in its entirety by reference.

### BACKGROUND OF THE INVENTION

1. Field of the Invention

The present invention relates to a mobile device, and more particularly to the mobile device using position and external condition to select related advertising and a selection method thereof, and related advertising is selected according a user's location and a situational parameter or a characteristic parameter and provided for the user's reference.

2. Description of Related Art

Location-based service (LBS) is also known as location appropriateness service, mobile positioning service, location service, or at-the-location service. As the name suggests, location-based service is a service determined by the location and provided to users based on many locations, and primarily obtains the positional information (such as geographic coordinates) of user's mobile terminal through a wireless communication network of a mobile communication company or an external positioning method. Wherein, the wireless communication network is a global system for mobile communications (GSM) or code division multiple access (CDMA) network, and the external positioning method is a global positioning system (GPS) method.

As science and technology advance, a navigation device generally providing users a route planning only is gradually developed to be a device connected to the Internet. Therefore, if the navigation device can integrate the location-based service to provide services and information based on a user's current position, it will make the applications more convenient to users.

As to the user requirements, it is one of the urgent issues for related designers and manufacturers to design and develop a mobile device using position and external condition to select related advertising and a selection method thereof.

### SUMMARY OF THE INVENTION

In view of the aforementioned problems of the prior art, it is a primary objective of the invention to provide a mobile device using position and external condition to select related advertising and a selection method thereof, so as to select and provide related advertising information based on the position and the external condition.

To achieve the foregoing objective, the present invention provides a mobile device using position and external condition to select related advertising, and the mobile device comprises a storage module, a positioning module, a processing module and a display module. The storage module is provided for storing a plurality pieces of advertising information. The positioning module is provided for receiving a current position of the mobile device. The processing module is provided for reading a situational parameter of the mobile device or a characteristic parameter of a target user, and reading a plurality pieces of corresponding advertising information corresponding to the current position and the situational parameter or the characteristic parameter from the plurality pieces of advertising information according to the current position, and the situational parameter or the characteristic parameter. The display module is electrically connected to the processing module for displaying the plurality pieces of corresponding advertising information.

Wherein, the processing module calculates a moving speed according to at least two records of the current position received by the positioning module, and when the moving speed is greater than a predetermined speed, the processing module rereads the plurality pieces of corresponding advertising information corresponding to the current position and the situational parameter or the characteristic parameter from the plurality pieces of advertising information according to the current position of the mobile device, and the situational parameter or the characteristic parameter.

Wherein, the processing module calculates a moving speed according to at least two records of the current position received by the positioning module, and when the moving speed is smaller than a predetermined speed, the processing module is not reread the plurality pieces of advertising information of the storage module.

Wherein, the mobile device comprises a sensing module for sensing the situational parameter of the mobile device.

Wherein, the situational parameter sensed by the sensing module comprising a piece of season information, an external temperature or a weather condition.

Wherein, the processing module reads the plurality pieces of corresponding advertising information from the plurality pieces of advertising information according to the current position and the situational parameter, and when the sensing module senses the situational parameter again, the processing module rereads the plurality pieces of corresponding advertising information corresponding to the current position and the situational parameter from the plurality pieces of advertising information according to the current position of the mobile device and the situational parameter sensed by the sensing module.

Wherein, the mobile device further comprises an input module for inputting the characteristic parameter of the target user.

Wherein, the characteristic parameter inputted by the input module includes a gender, a blood type, a horoscope or a requirement setting.

Wherein, the processing module reads the plurality pieces of corresponding advertising information from the plurality pieces of advertising information according to the current position and the characteristic parameter, and when the input module inputs the characteristic parameter again, the processing module reads the plurality pieces of corresponding advertising information corresponding to the current position and the characteristic parameter from the plurality pieces of advertising information according to the current position of the mobile device and the characteristic parameter inputted afresh by the input module.

To achieve the aforementioned objective, the present invention further provides a selection method using position and external condition to select related advertising, and the selection method is applicable in a mobile device, and the mobile device comprises a storage module, a positioning module, a processing module and a display module, and the selection method comprises the steps of using the storage module to store a plurality pieces of advertising information; receiving a current position of the mobile device through the positioning module; reading a situational parameter of the mobile device or a characteristic parameter of a target user by the processing module; using the processing module to read a plurality pieces of corresponding advertising information corresponding to the current position and the situational parameter or the characteristic parameter from the plurality pieces of advertising information according to the current position, and the situational parameter or the characteristic parameter; and displaying the plurality pieces of corresponding advertising information through the display module.

In summation, the mobile device using position and external condition to select related advertising and the selection method thereof in accordance with the present invention can actively provide possibly required information to user without manually looking up the point of interest, while determining and selecting related advertising information according to the situational parameter of the current position or the characteristic parameter of the user to provide various related advertising information based on position and external condition.

The above and other objects, features and advantages of the present invention will become apparent from the following detailed description taken with the accompanying drawings.

### BRIEF DESCRIPTION OF THE DRAWINGS

FIG. 1 is a block diagram of a mobile device of the present invention;

FIG. 2 is a first schematic view of a mobile device in accordance with a first preferred embodiment of the present invention;

FIG. 3 is a second schematic view of a mobile device in accordance with the first preferred embodiment of the present invention;

FIG. 4 is a first schematic view of a mobile device in accordance with a second preferred embodiment of the present invention;

FIG. 5 is a second schematic view of a mobile device in accordance with the second preferred embodiment of the present invention; and

FIG. 6 is a flow chart of a selection method of the present invention.

### DETAILED DESCRIPTION OF THE PREFERRED EMBODIMENTS

The technical contents and characteristics of a mobile device using position and external condition to select related advertising and a selection method thereof of the present invention will be apparent with the detailed description of a preferred embodiment accompanied with related drawings as follows. For simplicity, same numerals are used in the following preferred embodiment to represent respective same elements.

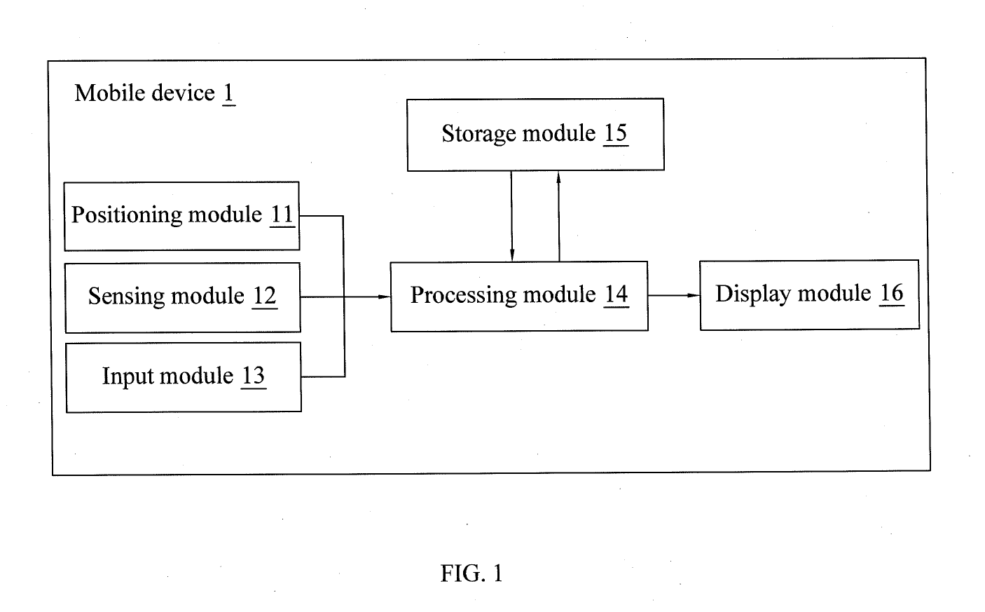

With reference to FIG. 1 for a block diagram of a mobile device 1 of the present invention, the mobile device 1 can select related advertising according to a position and an external condition. In FIG. 1, the mobile device 1 comprises a positioning module 11, a sensing module 12, an input module 13, a storage module 15, a processing module 14 and a display module 16. The positioning module 11 is provided for receiving a current position of the mobile device 1 according to a global positioning system (GPS). The sensing module 12 is provided for sensing a situational parameter of the mobile device 1, wherein the situational parameter includes but not limited to a piece of season information, an external temperature or a weather condition. The input module 13 is provided for inputting a characteristic parameter of a target user, wherein the characteristic parameter includes but not limited to a gender, a blood type, a horoscope or a requirement setting. The processing module 14 is a central processing unit (CPU) or a micro-processing unit for reading the situational parameter of the mobile device 1 or the characteristic parameter of the target user, and reading a plurality pieces of corresponding advertising information corresponding to the current position and the situational parameter or the characteristic parameter from the plurality pieces of advertising information according to the current position, and the situational parameter or the characteristic parameter. The storage module 15 is provided for storing the plurality pieces of advertising information. The display module 16 is a liquid crystal display (LCD) or a touch LCD screen electrically connected to the processing module 14 for displaying the plurality pieces of corresponding advertising information.

The processing module 14 calculates the current moving speed of the user according to at least two records of the current position received by the positioning module 11. If the moving speed is greater than a predetermined speed, the processing module 14 will reread the plurality pieces of corresponding advertising information corresponding to the current position and the situational parameter or the characteristic parameter from the plurality pieces of advertising information according to the current position of the mobile device, and the situational parameter or the characteristic parameter. If the moving speed is smaller than the predetermined speed, the processing module 14 will not reread the plurality pieces of advertising information from the storage module 15.

In the meantime, the processing module 14 reads the corresponding advertising information from the plurality pieces of advertising information according to the current position and the situational parameter. If the sensing module 12 senses the situational parameter again, the processing module 14 will reread plurality pieces of corresponding advertising information corresponding to the current position and situational parameter from the plurality pieces of advertising information according to the current position of the mobile device 1 and the situational parameter sensed by the sensing module 12. In addition, the processing module 14 reads the plurality pieces of corresponding advertising information according to the current position and the characteristic parameter, and if the input module 13 inputs a characteristic parameter, the processing module 14 rereads the plurality pieces of corresponding advertising information corresponding to the current position and the characteristic parameter according to the current position of the mobile device 1 and a characteristic parameter inputted afresh by the input module 13.

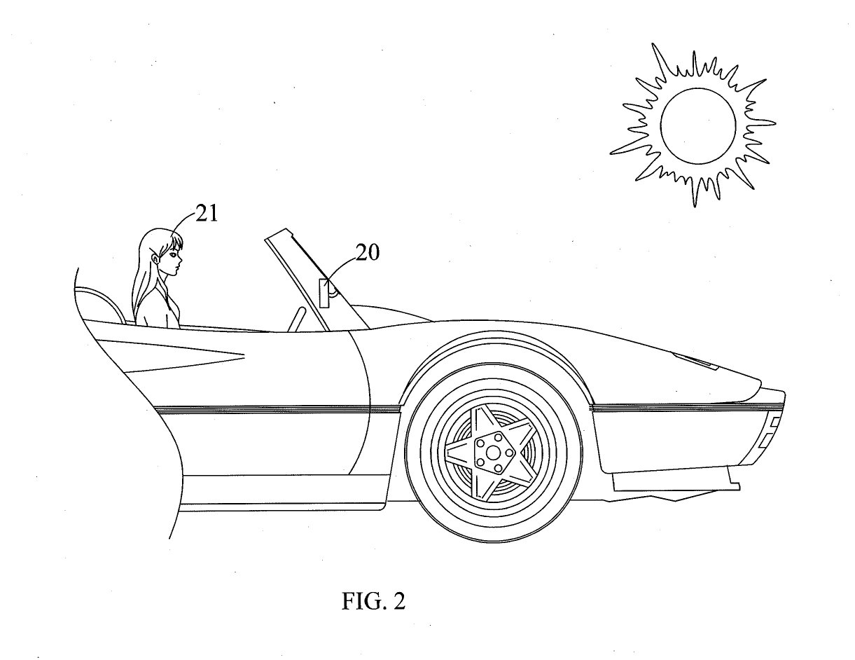

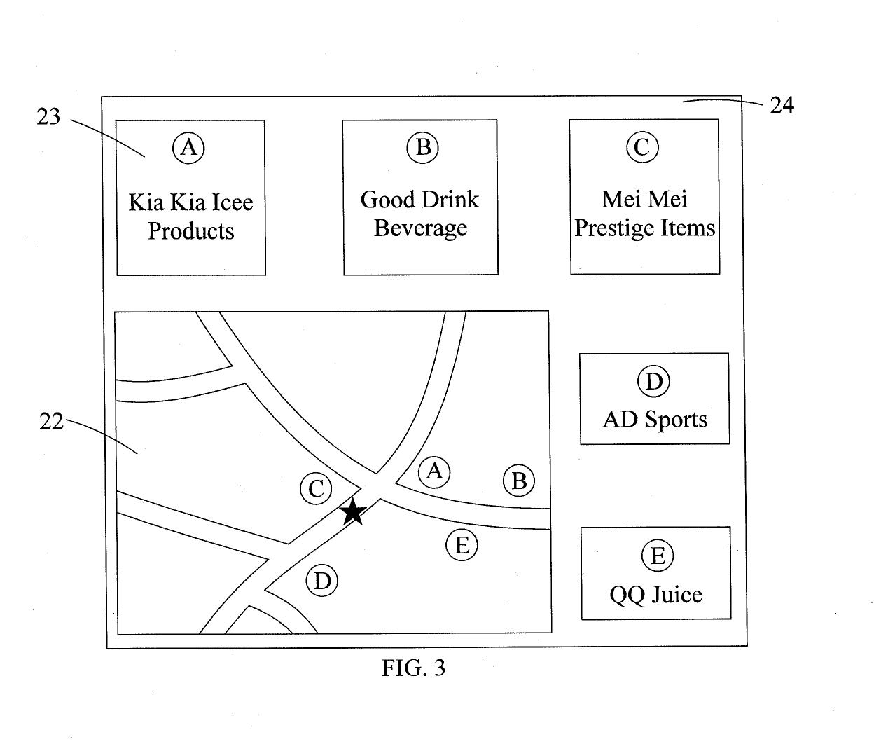

With reference to FIGS. 2 and 3 for the first and second schematic views of a mobile device in accordance with the first preferred embodiment of the present invention respectively, the mobile device is a device with a navigation function such as a personal digital assistant (PDA) or a portable navigation device with a navigation function. To make it easy to understand the technical characteristics of the present invention, the mobile device of this preferred embodiment is a portable navigation device 20, but the invention is not limited to the portable navigation device only.

In FIG. 2, a female driver 21 drives a car with a portable navigation device 20, and the driver 21 can use a positioning module of the navigation device 20 to receive a current position of the driver 21 for positioning the current position of a driver purpose. It is noteworthy to point out that the navigation device 20 includes a sensing module for sensing a situational parameter of the navigation device 20, wherein the situational parameter is a piece of season information, an external temperature or a weather condition. In addition, the driver 21 can input a characteristic parameter or a special requirement such as a gender, a blood type, a horoscope, a hobby or a requirement setting of the driver 21 through the navigation device 20. For example, in this preferred embodiment, the sensing module of the navigation device 20 can detect the temperature in Celsius (approximately equal to 27° C.) and relative humidity of air (approximately equal to 55%) of the outdoor environment where the driver 21 is situated. In the meantime, the driver 21 can input the gender is female, the hobby is sport, and the special requirement is a beverage lover.

With reference to FIG. 3, the contents of a display screen 24 of the navigation device include a map 22 and the plurality pieces of corresponding advertising information 23. In this preferred embodiment, an asterisk displayed in the map 22 represents the current position of the driver 21. The driver 21 can use the processing module of the navigation device 20 to read related advertising information corresponding to the position, external condition or characteristic parameter in the storage module of the navigation device 20 according to the current position of the driver 21, a temperature in Celsius of an outdoor environment, a situational parameter relative humidity of air, or a characteristic parameter of the driver 21 such as the gender, hobby or special requirement. In other words, the sensing module of the navigation device 20 can sense that the temperature in Celsius of the outdoor environment is approximately equal to 27° C., and the relative humidity of air is approximately equal to 55%, and the characteristic parameter or special requirement is inputted by the input module, so that a display screen 24 of navigation device 20 can display five pieces of advertising information 23 in compliance with the requirements of the driver 21 and located at Location A, Location B, Location C, Location D and Location E.

It is noteworthy to point out that the processing module of the navigation device 20 can calculate a moving speed of the navigation device 20 according to at least two records of the current position received by the positioning module. For example, the navigation device 20 can preset a predetermined speed to 5 Km/h according to the actual requirement. If the moving speed of the navigation device 20 is 40 Km/h which is greater than 5 Km/h, the processing module will reread the advertising information. If the moving speed of the navigation device 20 is 0 Km/h which is smaller than 5 Km/h, the processing module will not read the advertising information again. To illustrate the technical characteristics of the present invention, the foregoing predetermined speed is used as an example, but not intended for limiting the scope of the invention.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

Based on the first preferred embodiment, the present invention further provides a second preferred embodiment to illustrate the technical characteristics of the invention.

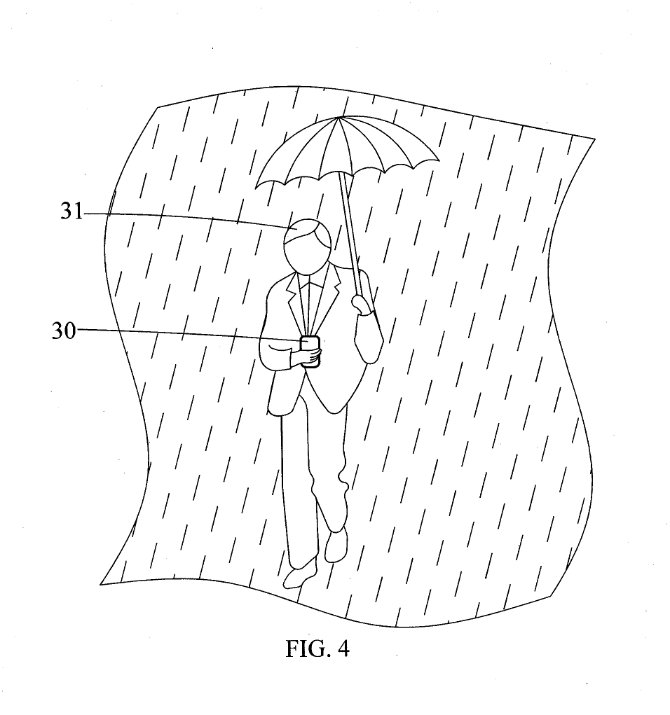

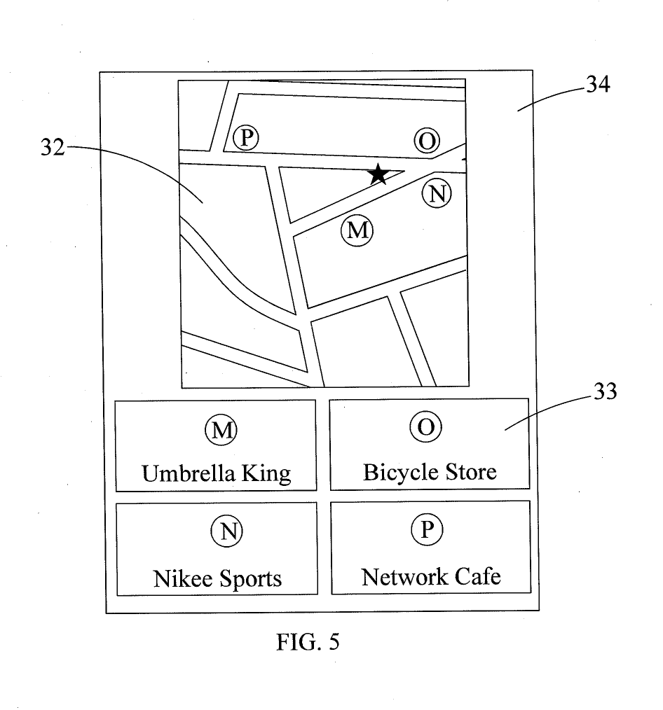

With reference to FIGS. 4 and 5 for the first and second schematic views of a mobile device in accordance with the second preferred embodiment of the present invention respectively, the mobile device is a device with a navigation function such as a personal digital assistant (PDA) or a portable navigation device with a navigation function. To make it easy to understand the technical characteristics of the present invention, the mobile device of this preferred embodiment is a PDA 30, but the invention is not limited to the PDA only.

In FIG. 4, a user 31 holding the PDA 30 is a male, and the PDA 30 has a navigation function, and the user 31 can use a positioning module of the PDA 30 to receive the current position of the user 311 for the positioning purpose. It is noteworthy to point out that the PDA 30 includes a sensing module for sensing a situational parameter such as a piece of season information, an external temperature or a weather condition of the PDA 30. In addition, the user 31 can input a characteristic parameter or a special requirement such as the gender, blood type, horoscope, hobby or requirement setting of the user 31 through the PDA 30, but the characteristic parameter and special requirements are not limited to the foregoing arrangement only. In this preferred embodiment, the sensing module of the PDA 30 can sense the outdoor environment temperature or the relative humidity of air where the user 31 is situated. In the meantime, the user 31 can input the gender as a male, the hobby as riding bicycle and playing computer games.

With reference to FIG. 5, the contents of a display screen 34 of the navigation device include a map 32 and plurality pieces of corresponding advertising information 33. In this preferred embodiment, an asterisk displayed in the map 32 represents the current position of the user 31. The user 31 can use the processing module of the PDA 30 to read advertising information related the position, situational parameter or characteristic parameter according to the current position of the user 31, a temperature in Celsius of an outdoor environment, a situational parameter relative humidity of air, or a characteristic parameter of the user 31 such as the gender, hobby or special requirement. Therefore, the display screen 34 of the PDA 30 can display four pieces of corresponding advertising information 33 in compliance with the requirements of the user 31 and situated at Location M, Location N, Location O and Location P respectively. For example, the user 31 is walking in the rain, the display screen 34 of the PDA 30 can display the corresponding advertising information 33, such as an advertisement of Umbrella King provided as the reference for the user 31, and the map 32 can show the Location M to guide the user 31 to the destination.

Although the concept of the selection method of the present invention has been described in the section of the mobile device of the present invention, the following flow chart is provided for further illustrating the invention.

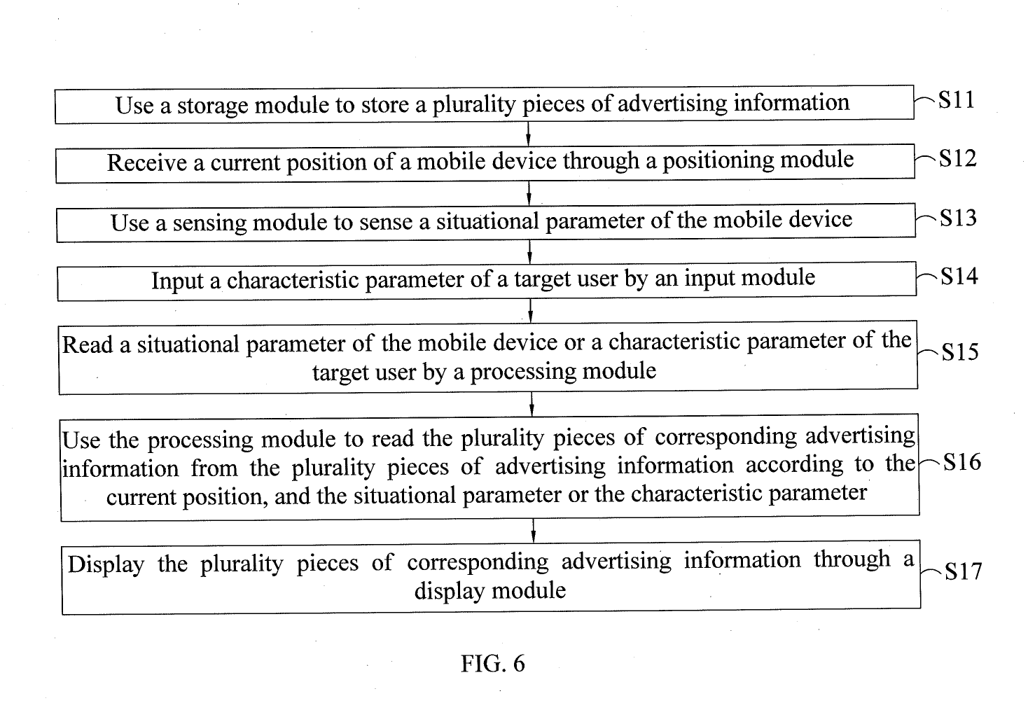

With reference to FIG. 6 for the flow chart of the selection method of the present invention, the selection method selects a related advertising based on position and external condition, and the method is applied in a mobile device. The mobile device comprises a positioning module, a sensing module, an input module, a storage module, a processing module and a display module, and the selection method of the mobile device comprises the following steps:

S11: Use a storage module to store a plurality pieces of advertising information.

S12: Receive a current position of a mobile device through a positioning module.

S13: Use a sensing module to sense a situational parameter of the mobile device.

S14: Input a characteristic parameter of a target user by an input module.

S15: Read a situational parameter of the mobile device or a characteristic parameter of the target user by a processing module.

S16: Use the processing module to read the plurality pieces of corresponding advertising information from the plurality pieces of advertising information according to the current position, and the situational parameter or the characteristic parameter.

S17: Display the plurality pieces of corresponding advertising information through a display module.

The detailed description and implementation of the selection method of the mobile device in accordance with the present invention have been described in the section of the mobile device of the present invention, and thus they will not be described again.

In summation, the mobile device using position and external condition to select related advertising of the present invention and the selection method thereof have one or more of the following advantages:

(1) The mobile device using position and external condition to select related advertising and the selection method thereof can actively provide possibly required information to user without manually looking up the point of interest.

(2) The mobile device using position and external condition to select related advertising and the selection method thereof can determine and select the related advertising information according to the situational parameter of the environment or the characteristic parameter of the user to provide various related advertising information based on position and external condition.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mobile device, using position and external condition to select related advertising, and the mobile device comprising:
a storage module, arranged for storing a plurality pieces of advertising information;
a positioning module, arranged for receiving a current position of the mobile device;
a processing module, arranged for reading a situational parameter of the mobile device or a characteristic parameter of a target user, and reading a plurality pieces of corresponding advertising information corresponding to the current position and the situational parameter or the characteristic parameter from the plurality pieces of advertising information according to the current position, and the situational parameter or the characteristic parameter; and
a display module, being electrically connected to the processing module for displaying the plurality pieces of corresponding advertising information.

2. The mobile device of claim 1, wherein the processing module calculates a moving speed according to at least two records of the current position received by the positioning module, and when the moving speed is greater than a predetermined speed, the processing module rereads the plurality pieces of corresponding advertising information corresponding to the current position and the situational parameter or the characteristic parameter from the plurality pieces of advertising information according to the current position of the mobile device, and the situational parameter or the characteristic parameter.

3. The mobile device of claim 2, wherein the display module displays the plurality pieces of corresponding advertising information updated by the processing module.

4. The mobile device of claim 1, wherein the processing module calculates a moving speed according to at least two records of the current position received by the positioning module, and when the moving speed is smaller than a predetermined speed, the plurality pieces of advertising information of the storage module are not reread by the processing module.

5. The mobile device of claim 1, further comprising a sensing module for sensing the situational parameter of the mobile device.

6. The mobile device of claim 5, wherein the situational parameter sensed by the sensing module comprising a piece of season information, an external temperature or a weather condition.

7. The mobile device of claim 5, wherein the processing module reads the plurality pieces of corresponding advertising information from the plurality pieces of advertising information according to the current position and the situational parameter, and when the sensing module senses the situational parameter again, the processing module rereads the plurality pieces of corresponding advertising information corresponding to the current position and the situational parameter from the plurality pieces of advertising information according to the current position of the mobile device and the situational parameter sensed afresh by the sensing module.

8. The mobile device of claim 1, further comprising an input module for inputting the characteristic parameter of the target user.

9. The mobile device of claim 8, wherein the characteristic parameter inputted by the input module includes a gender, a blood type, a horoscope or a requirement setting.

10. The mobile device of claim 8, wherein the processing module reads the plurality pieces of corresponding advertising information from the plurality pieces of advertising information according to the current position and the characteristic parameter, and when the input module inputs the characteristic parameter again, the processing module rereads the plurality pieces of corresponding advertising information corresponding to the current position and the characteristic parameter from the plurality pieces of advertising information according to the current position of the mobile device and the characteristic parameter inputted afresh by the input module.

11. A selection method, using position and external condition to select related advertising, and the selection method being applied in a mobile device, and the mobile device comprising a storage module, a positioning module, a processing module and a display module, and the selection method comprising the steps of:
using the storage module to store a plurality pieces of advertising information;
receiving a current position of the mobile device through the positioning module;
reading a situational parameter of the mobile device or a characteristic parameter of a target user by the processing module;
using the processing module to read a plurality pieces of corresponding advertising information corresponding to the current position and the situational parameter or the characteristic parameter from the plurality pieces of advertising information according to the current position, and the situational parameter or the characteristic parameter; and
displaying the plurality pieces of corresponding advertising information through the display module.

12. The selection method of claim 11, further comprising the steps of:
using the processing module to calculate a moving speed according to at least two records of the current position received by the positioning module; and
using the processing module to reread the plurality pieces of corresponding advertising information corresponding to the current position and the situational parameter or the characteristic parameter from the plurality pieces of advertising information according to the current position of the mobile device, and the situational parameter or the characteristic parameter, when the moving speed is greater than a predetermined speed.

13. The selection method of claim 12, further comprising the step of displaying the plurality pieces of corresponding advertising information updated by the processing module through the display module.

14. The selection method of claim 11, further comprising the steps of:
using the processing module to calculate a moving speed according to at least two records of the current position received by the positioning module; and
not rereading the plurality pieces of advertising information from the storage module using the processing module when the moving speed is smaller than a predetermined speed.

15. The selection method of claim 11, further comprising the step of using a sensing module of the mobile device to sense the situational parameter of the mobile device.

16. The selection method of claim 15, wherein the situational parameter sensed by the sensing module includes a piece of season information, an external temperature or a weather condition.

17. The selection method of claim 15, further comprising the steps of
using the processing module to read the plurality pieces of corresponding advertising information from the plurality pieces of advertising information according to the current position and the situational parameter; and
using the processing module to reread the plurality pieces of corresponding advertising information corresponding to the current position and the situational parameter from the plurality pieces of advertising information according to the current position of the mobile device and the situational parameter sensed afresh by the sensing module, if the sensing module senses the situational parameter again.

18. The selection method of claim 11, further comprising the step of using an input module of the mobile device to input the characteristic parameter of the target user.

19. The selection method of claim 18, wherein the characteristic parameter inputted by the input module includes a gender, a blood type, a horoscope or a requirement setting.

20. The selection method of claim 18, further comprising the steps of:
using the processing module to read the plurality pieces of corresponding advertising information from the plurality pieces of advertising information according to the current position and the characteristic parameter; and
using the processing module to reread the plurality pieces of corresponding advertising information corresponding to the current position and the characteristic parameter from the plurality pieces of advertising information according to the current position of the mobile device and the characteristic parameter inputted afresh by the input module, if the input module inputs the characteristic parameter again.
